(19) United States
(12) Patent Application Publication
(10) Pub. No.: US 2009/0244018 A1
(43) Pub. Date: Oct. 1, 2009

(54) TOUCH PANEL MODULE AND METHOD FOR DETERMINING POSITION OF TOUCH POINT ON TOUCH PANEL

(76) Inventors: Ching-Chang Lin, Hsinchu County (TW); Sheng-Min Chou, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/116,201

(22) Filed: May 7, 2008

(30) Foreign Application Priority Data
Mar. 28, 2008 (CN) 200810027131.3

(51) Int. Cl. G06F 3/041

(52) U.S. Cl. 345/173

(57) ABSTRACT

A touch panel module includes a surface panel, a band splitter, an optical unit and a control unit. Retro-reflectors are respectively positioned on three peripheral sides of the surface panel, and the band splitter is positioned on the retro-reflector positioned at one peripheral side of the surface panel, where the band splitter totally reflects a light beam within a first band while a light beam with a second band transmits through the band splitter. The optical unit is utilized for generating a first band beam within the first band and for receiving a reflected first band beam from one of the retro-reflectors to generate a first signal, and the control unit performs touch point detection according to the first signal.

### BACKGROUND OF THE INVENTION

1. Field of the Invention

The present invention relates to touch panels, and more particularly, to optical touch panel modules and methods for determining a position of a touch point on the optical touch panel.

2. Description of the Prior Art

In conventional optical photographic touch panels, the touch panel needs at least two photographic fetching units to calculate a position of a touch point (please refer to US 20030234346 A1). In the conventional optical scanning touch panel, two optical units and retro-reflectors are utilized to calculate a position of a touch point (please refer to US 20030020008 A1). When a scanning touch panel calculates a position of a touch point according to only one optical unit (please refer to EP 0362109), the position of the touch point in some specific regions cannot be accurately calculated.

### SUMMARY OF THE INVENTION

It is therefore one of the objectives of the claimed invention to provide touch panel modules and methods for determining a position of a touch point on the touch panel. The touch panel module only requires one optical sensor unit to perform touch point detection, and the position of the touch point in some specific regions can also be accurately calculated, thereby solving the above-mentioned problems.

According to one embodiment of the present invention, a touch panel module comprises a surface panel, a mirror, a photographic fetching unit, and a control unit. Borders with a setting pattern are positioned at a first side and a second side of the surface panel, and the second side neighbors the first side. The mirror is positioned at a third side of the surface panel, where the third side is opposite to the first side. The photographic fetching unit is utilized to fetch a physical image of the second side and a mirrored image of the first and second side of the surface panel. The control unit is utilized to perform touch point detection according to the images of the first and the second side of the surface panel fetched by the photographic fetching unit.

According to another embodiment of the present invention, a touch panel comprises a surface panel, a band splitter, an optical unit, and a control unit. A first retro-reflector, a second retro-reflector, and a third retro-reflector are respectively positioned at a first side, a second side, and a third side of the surface panel, where the second side neighbors the first side, and the third side neighbors the second side. The band splitter is positioned upon the third retro-reflector, where a light beam having frequencies within a first band is totally reflected by the band splitter, and a light beam having frequencies within a second band transmits to the band splitter. The optical unit is utilized to generate a first band light beam having frequencies within the first band, and is utilized to receive a reflected first band light beam reflected by one of the first and second retro-reflectors to generate a first signal. The control unit performs touch point detection according to the first signal.

According to another embodiment of the present invention, a method for determining a position of a touch panel on a touch panel is disclosed. The method comprises: positioning borders with a setting pattern at a first side and a second side of a surface panel, wherein the second side neighbors the first side; positioning a mirror at a third side of the surface panel, wherein the third side is opposite to the first side; fetching a physical image of the second side and a mirrored image of the first and second side of the surface panel; and performing touch point detection according to fetched images of the first and the second side of the surface panel.

According to another embodiment of the present invention, a method for determining a position of a touch panel on a touch panel is disclosed. The method comprises: respectively positioning a first retro-reflector, a second retro-reflector, and a third retro-reflector at a first side, a second side, and a third side of a surface panel, wherein the second side neighbors the first side, and the third side neighbors the second side; positioning a band splitter upon the third retro-reflector, wherein a light beam having frequencies within a first band is totally reflected by the band splitter, and a light beam having frequencies within a second band transmits to the band splitter; generating a first band light beam having frequencies within the first band; receiving a reflected first band light beam reflected by one of the first and second retro-reflectors to generate a first signal; and performing touch point detection according to the first signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a touch panel module according to a first embodiment of the present invention.

FIG. 2 is a flowchart illustrating operations of the touch panel module shown in FIG. 1.

FIG. 3 is a diagram illustrating a touch panel module according to a second embodiment of the present invention.

FIG. 4 is a diagram illustrating the optical unit according to a first embodiment shown in FIG. 3.

FIG. 5 is a flowchart illustrating operations of the touch panel module shown in FIG. 3.

FIG. 6 is a diagram illustrating determination of the angles α, β shown in FIG. 3 according to the first signal.

FIG. 7 is a diagram illustrating the first signal having only one pulse.

FIG. 8 is a diagram illustrating the touch point detection by using the second band light beam.

FIG. 9 is a diagram illustrating the optical unit according to a second embodiment shown in FIG. 3.

FIG. 10 is a diagram illustrating a touch panel module according to a third embodiment of the present invention.

FIG. 11 is a diagram illustrating the first signal having four pulses.

### DETAILED DESCRIPTION

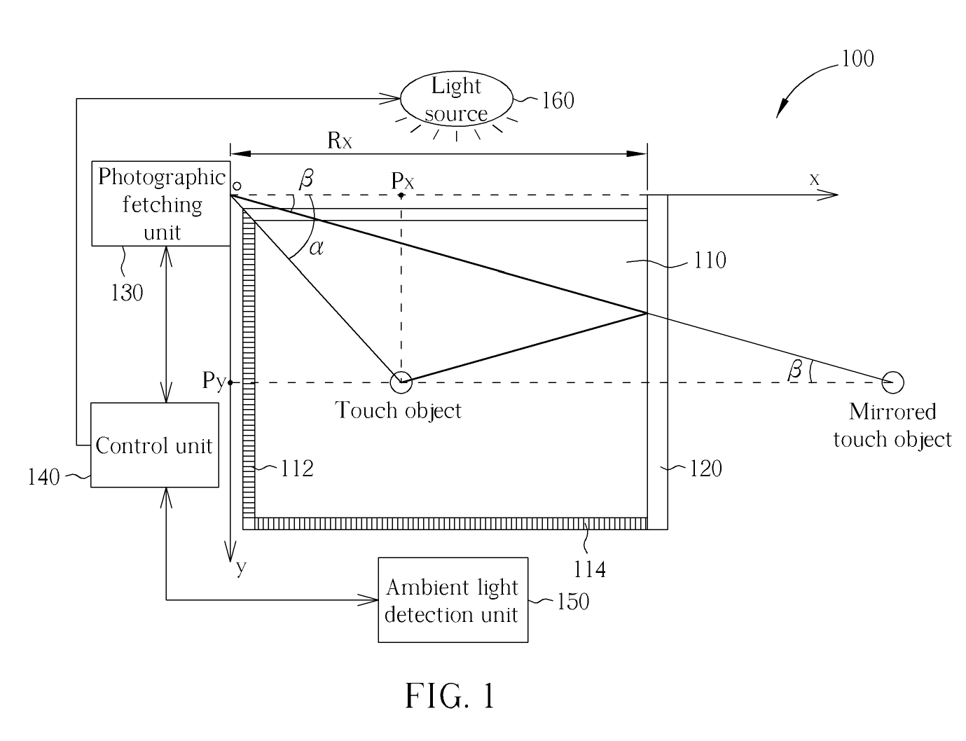

Please refer to FIG. 1. FIG. 1 is a diagram illustrating a touch panel module according to a first embodiment of the present invention. As shown in FIG. 1, the touch panel module 100 comprises a surface panel 110, a mirror 120, a photographic fetching unit 130, a control unit 140, an ambient light detection unit 150, and a light source 160. The borders 112, 114 with a setting pattern are positioned at a first side and a second side of the surface panel 110, where the second side neighbors the first side. The mirror 120 is positioned at a third side of the surface panel 110, where the third side is opposite to the first side.

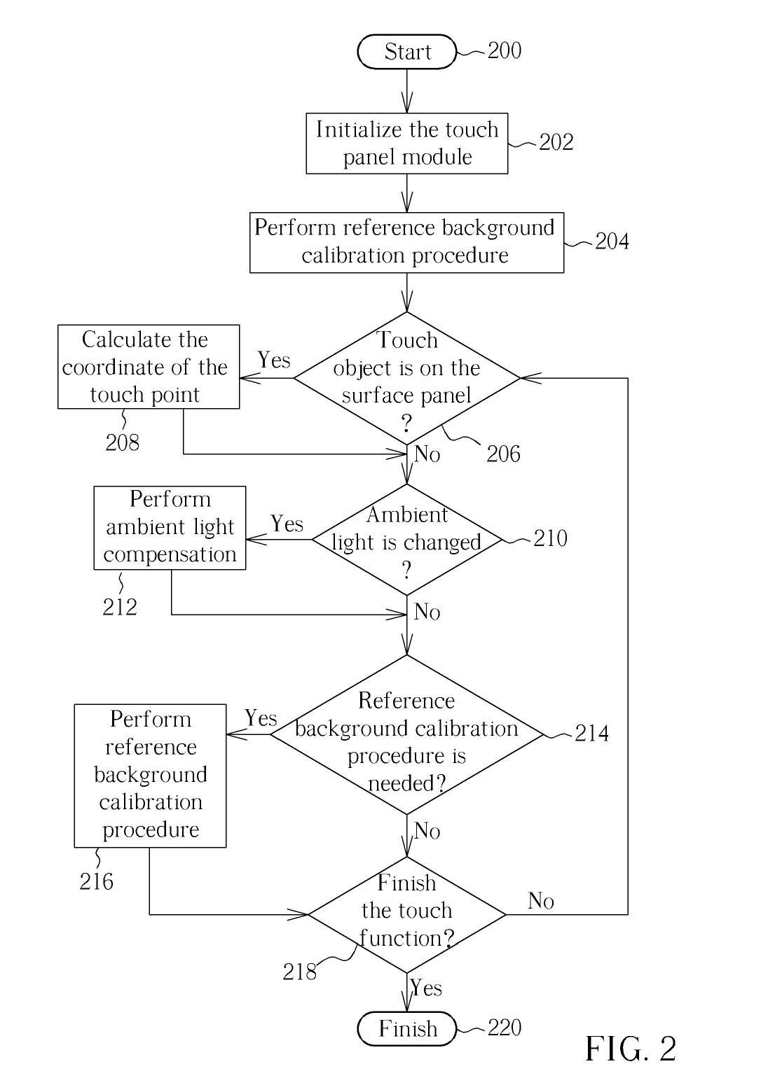

Please refer to FIG. 2 together with FIG. 1. FIG. 2 is a flowchart illustrating operations of the touch panel module 100 shown in FIG. 1. Please note that, provided that the result is substantially the same, the steps are not limited to be executed according to the exact order shown in FIG. 2. Referring to the flowchart shown in FIG. 2, the operations of the touch panel module 100 are described as follows:

In Step 200, the touch function of the touch panel module 100 is activated. In Step 202, the touch panel module 100 is initialized. In Step 204, a reference background calibration procedure is performed to update a reference background image in real-time. In the reference background calibration procedure, an image fetched by the photographic fetching unit 130 is compared with a reference background image (the reference background image is an image fetched by the photographic fetching unit 130 when there is no touch point on the surface panel 110) to detect if there is dust, spots or undesired objects on the surface panel 110. When the surface panel 100 suffers the above conditions which may influence the determination of the touch point, a message or an alert can be used to notify the user to remove the undesired objects, or directly update the reference background image, to make sure that the following touch point detection can be performed accurately. After finishing the reference background calibration procedure, in Step 206, the control unit 140 determines if a touch object is on the surface panel 110 or not according to the images fetched by the photographic fetching unit 130. When there is a touch point (touch object) on the surface panel 110, the flow enters Step 208; otherwise, the flow enters Step 210. In Step 208, a coordinate of the touch point on the surface panel 110 is determined according to the images fetched by the photographic fetching unit 130. Regarding the operations of determining the coordinate of the touch point on the surface panel 110, the photographic fetching unit 130 first fetches a physical image of the second side and a mirrored image of the first and second side of the surface panel 110. Then an image recognizing skill is utilized to determine the positions of the touch point corresponding to the physical image and the mirrored image (i.e., the positions of the physical touch point and the mirrored touch point), and values of two angles α, β are calculated (or obtained by a look-up table) based on a reference line (x-axis shown in FIG. 1). The coordinate of the touch point on the surface panel 110 is calculated by the following formula:

$$( Px , Py ) = ( \frac{2 Rx \cdot tan β}{tan α + tan β} , \frac{2 Rx \cdot tan α \cdot tan β}{tan α + tan β} )$$

In this embodiment, a position of the photographic fetching unit 130 is set as the origin O of x-y coordinates.

Px is a value of the x-coordinate of the touch point;

Py is a value of the y-coordinate of the touch point;

Rx is a horizontal distance between the photographic fetching unit 130 and the mirror 120;

α is the value of the angle between the reference line and a line crossing an origin of x-y coordinates and the position of the touch point;

β is the value of the angle between the reference line and a line crossing the origin of x-y coordinates and the position of the mirrored touch point.

In Step 210, the ambient light detection unit 150 detects the intensity of the ambient light in a specific region. If the intensity of the ambient light in the specific region does not change, the flow enters Step 214; otherwise, the flow enters Step 212 to perform operations of the ambient light compensation. That is, brightness of the light source is adjusted according to an ambient light detection result. When the ambient light is not sufficient to recognize the images fetched by the photographic fetching unit 130, brightness of the light source 160 is increased to improve the recognition rate; and when the ambient light is sufficient or over the required value, the brightness of the light source 160 is decreased or even shut down to save energy. In Step 214, it is determined if the reference background calibration procedure is needed. If it is needed, the flow enters Step 216; otherwise, the flow enters Step 218. The operations of Step 214 and Step 216 are the same as Step 204, and therefore, further descriptions are omitted here. In Step 218, it is determined if the touch function of the touch panel module 100 needs to be finished or not. If not, the flow returns to Step 206 and performs touch point detection; if yes, the flow enters Step 220 to finish the touch function of the touch panel module 100.

It is noted that the ambient light detection in Step 210 and the ambient light compensation in Step 212 are optional operations, that is, in other embodiments of the present invention, the touch panel module 100 can be correctly operated without performing Steps 210 and 212. Similarly, the ambient light detection unit 150 and the light source 160 shown in FIG. 1 can also be removed. In addition, the method of calculating the coordinate of touch point according to the angles α, β is merely an example; as long as the position of the touch point is determined according to the fetched images of the first and second sides of the surface panel 110, and the image of the first side is a mirrored image of the border with the setting pattern, a person skilled in this art can calculate the coordinate of the touch point by using the image recognition and other triangulation techniques. The alternative designs are all within the scope of the present invention.

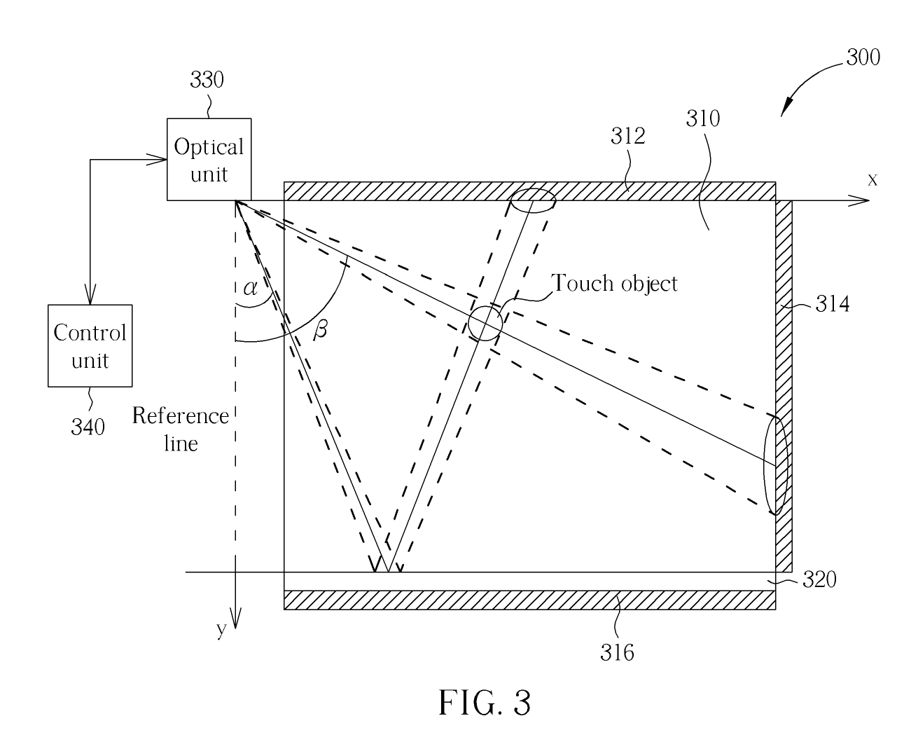

Please refer to FIG. 3. FIG. 3 is a diagram illustrating a touch panel module according to a second embodiment of the present invention. As shown in FIG. 3, the touch panel module 300 comprises a surface panel 310, a first retro-reflector 312, a second retro-reflector 314, a third retro-reflector 316, a band splitter 320, an optical unit 330, and a control unit 340, where the first, second, and third retro-reflectors 312, 314, 316 are positioned at a first side, a second side, and a third side of the surface panel 310, respectively. In addition, the band splitter 320 is positioned upon the third retro-reflector 316, where a light beam having frequencies within a first band is totally reflected by the band splitter 320, and a light beam having frequencies within a second band transmits to the band splitter 320.

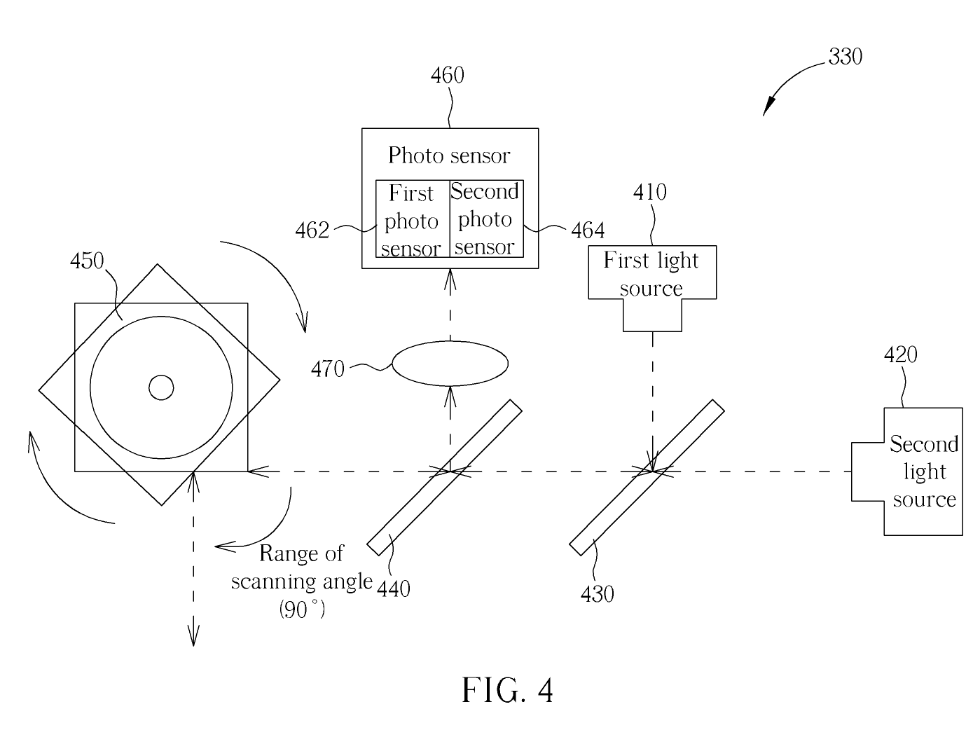

Please refer to FIG. 4. FIG. 4 is a diagram illustrating the optical unit according to a first embodiment of the touch panel module shown in FIG. 3. As shown in FIG. 4, the optical unit 330 comprises a first light source 410, a second light source 420, a band splitter 430, a beam splitter 440, a polygon mirror 450, a photo sensor 460 and a lens 470, where the photo sensor 460 comprises a first photo sensor 462 and a second photo sensor 464. The first light source 410 is utilized to generate a first band light beam having frequencies within the first band, and the second light source 420 is utilized to generate a second band light beam having frequencies within the second band. The first band light beam will be totally reflected by the band splitter 430, and the second band light beam will be transmitted to the band splitter 430. In addition, a motor (not shown) is connected to the polygon mirror 450 to make the polygon mirror 450 rotate and reflect the light beam generated from the first light 410 source and the second light source 420 to the top of the surface panel 310. In this embodiment, the polygon mirror 450 is a quadrilateral (polygon with four sides) mirror, and a range of the scanning angle is 90°, that is, the scanning angle is in a range from the x-axis to y-axis shown in FIG. 3. In addition, in the following description, a scanning period is named as an interval that the light beam generated from the optical unit 330 scans clockwise from x-axis to y-axis.

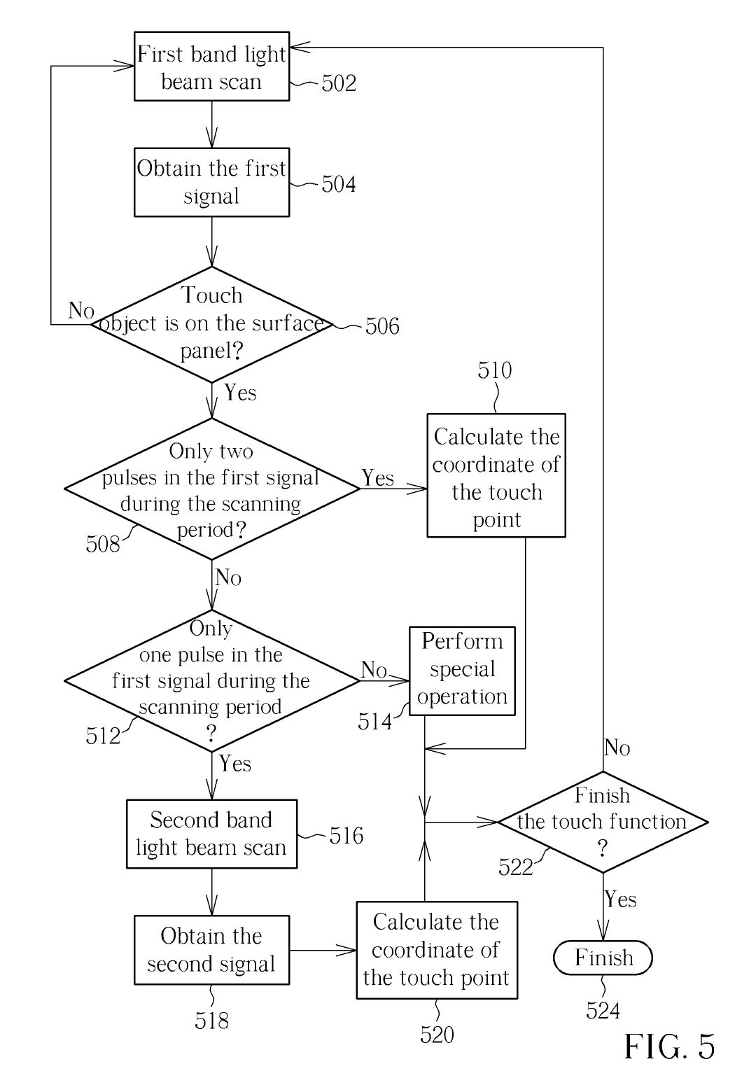

Please refer to FIG. 3, FIG. 4, and FIG. 5 together. FIG. 5 is a flowchart illustrating operations of the touch panel module 300 shown in FIG. 3. Please note that, provided that the result is substantially the same, the steps of the touch panel module 300 are not limited to be executed according to the exact order shown in FIG. 5. Referring to the flowchart shown in FIG. 5, the operations of the touch panel module 300 are described as follows:

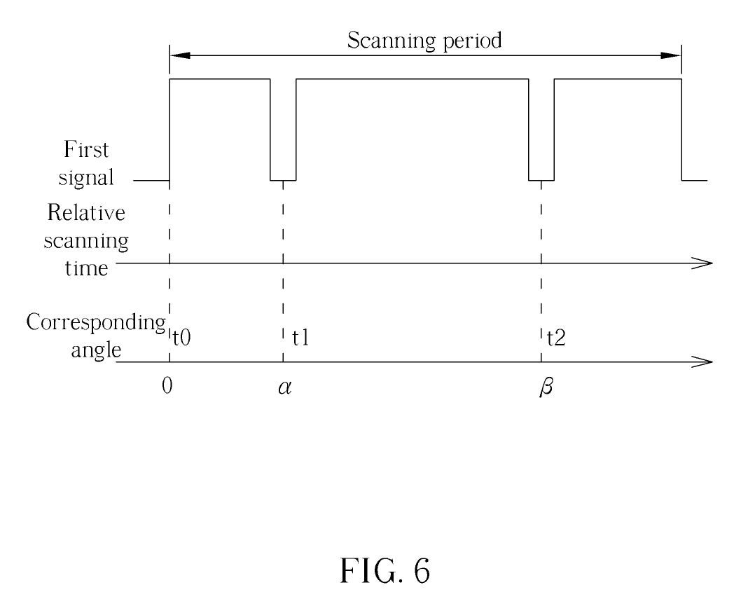

After the required operations such as the activation and the initialization process are executed, the touch panel module 300 performs touch point detection by the following steps. In Step 502, the first band light beam is generated from the first light source 410 in the optical unit 330, and goes through the band splitter 430, the beam splitter 440, and the polygon mirror 450 to scan over the surface panel 310. In Step 504, the first photo sensor 462 in the optical unit 330 receives a reflected first band light beam reflected by the second retro-reflector 314, and reflected by the first retro-reflector 312 and the band splitter 320 to generate a first signal. In this embodiment, the first signal is the intensity of the reflected first band light beam received by the first photo sensor 462. FIG. 6 is a diagram illustrating determining the angles α, β shown in FIG. 3 according to the first signal. In Step 506, it is determined if a touch object is on the surface panel 310 or not; if there is no pulse in the first signal during a scanning period (e.g., the pulse at time t1 and t2 shown in FIG. 6), no touch point is considered on the surface panel 310, the flow enters Step 502. However, if there are one or more pulses in the first signal during the scanning period, touch point(s) is considered on the surface panel 310, and the flow enters Step 508. The pulse here represents that the first band light beam is blocked by the touch object(s), and the first photo sensor 462 cannot receive the reflected first band light beam. In Step 508, it is determined if there are two pulses in the first signal during the scanning period, if yes, there is only one touch point on the surface panel 310 and its coordinate can be calculated, and the flow enters Step 510 to calculate the coordinate of the touch point; otherwise, the flow enters Step 512.

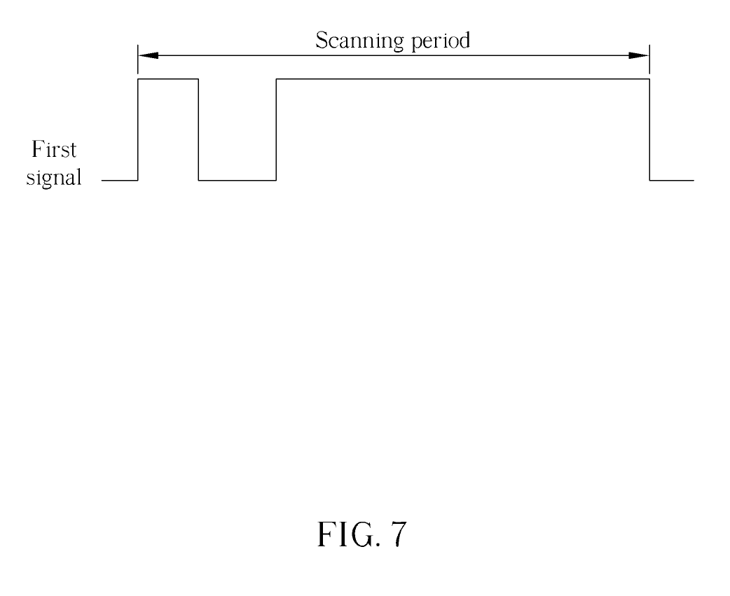

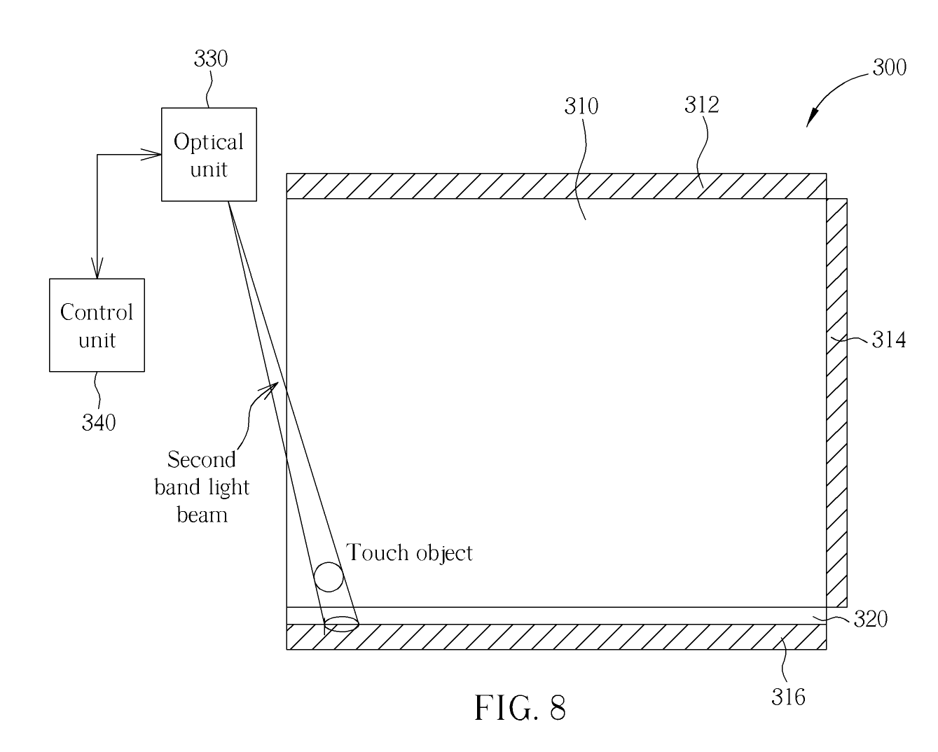

In Step 510, referring to FIG. 6, the two pulses in the first signal correspond to relative scanning times t1 and t2, and values of the two angles α, β are calculated according to the relative scanning times t1 and t2, and then α and β are utilized to calculate the coordinates of the touch point on the surface panel 310. The calculation of the coordinate of the touch point is similar to that of the touch panel module 100, and therefore detailed description is omitted here. In Step 512, it is determined if there is only one pulse in the first signal during the scanning period (shown in FIG. 7); if not, there may be more than one touch point or other conditions, and therefore the flow enters Step 514 to perform special operations. In addition, if there is only one pulse in the first signal, the flow enters Step 516. In Step 516, the first signal having only one pulse during a scanning period generally occurs due to a larger touch object and the touch point being at a specific region such as a lower left corner of the surface panel 310 shown in FIG. 3. At this time, central coordinates of the touch object and a width of the touch object cannot be accurately calculated. Therefore, in the present invention, the second light source 420 in the optical unit 330 is enabled to generate a second band light beam having frequencies within the second band. The second band light beam then goes through the band splitter 430, the beam splitter 440, and the polygon mirror 450 and scans over the surface panel 310. In Step 518, the second photo sensor 464 receives a reflected second band light beam reflected by one of the second retro-reflector 314 and the third retro-reflector 316 to generate a second signal as shown in FIG. 8. In Step 520, the control unit 340 performs touch point detection according to the first signal and the second signal, and calculates the width of the touch object or the central position of the touch object. After finishing Step 510, 514, or 520, the flow enters Step 522 to determine if the touch function needs to be finished or not. If yes, the flow enters Step 524 to disable the touch function of the touch panel module 300; otherwise, the flow returns to Step 502 to perform touch point detection.

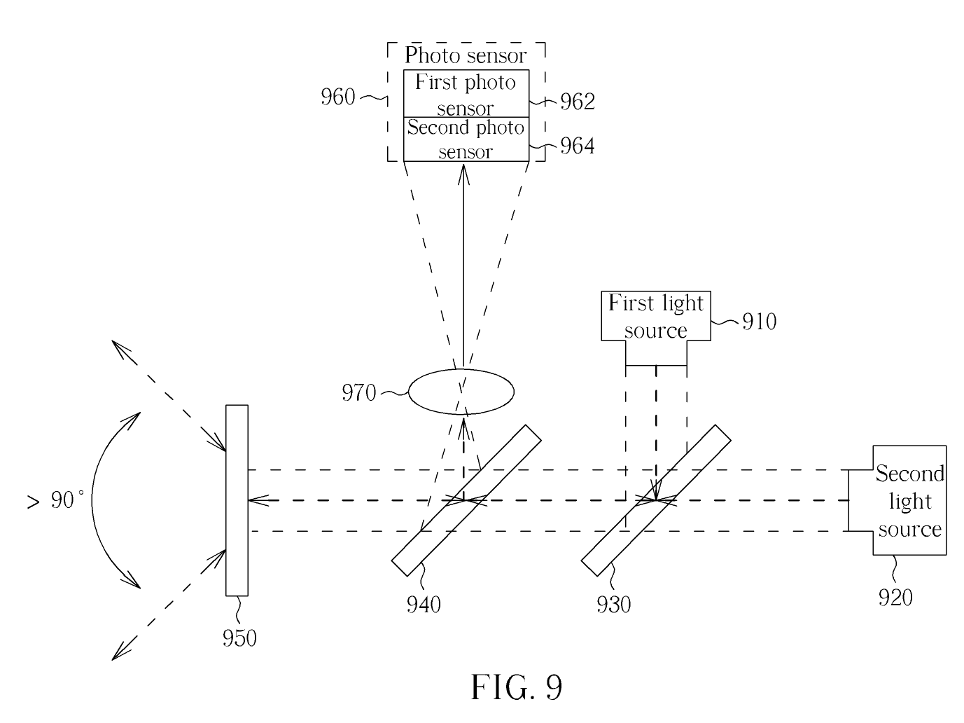

In addition, the optical unit 330 shown in FIG. 4 is merely an embodiment of the present invention. In practice, the optical unit 330 can emit light over the surface panel 310 without using the motor and the polygon mirror 450. Please refer to FIG. 9. FIG. 9 is a diagram illustrating the optical unit according to a second embodiment shown in FIG. 3. As shown in FIG. 9, the optical unit 330 comprises a first light source 910, a second light source 920, a band splitter 930, a beam splitter 940, a lens assembly 950, a photo sensor 960, and a lens 970, where the photo sensor 960 comprises a first photo sensor 962 and a second photo sensor 964. In this embodiment, the first photo sensor 962 and the second photo sensor are charge coupled devices (CCD) or complementary metal-oxide semiconductors (CMOS). The first light source 910 is utilized to generate the first band light beam having frequencies within the first band, and the second light source 920 is utilized to generate the second band light beam having frequencies within the second band, where the first band light beam is totally reflected by the band splitter 930, and the second band light beam transmits to the band splitter 930. In addition, the lens assembly diverges the light beam generated from the first light source 910 and the second light source 920 to generate a diverged light beam, and the diverging angle is greater than 90°.

In addition, when there are two touch objects on the surface panel, conventional touch panel (referring to US 20030020008 A1) and the touch panel module 300 of the present invention cannot determine positions of the two touch objects because two solutions are obtained. Therefore, another embodiment is provided to solve this problem.

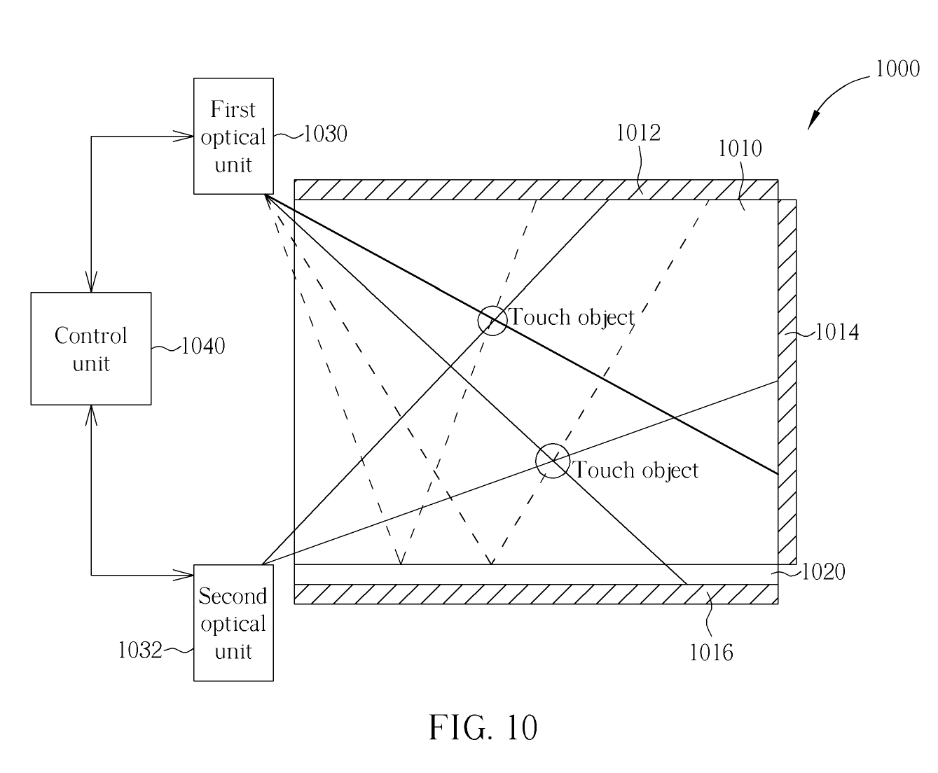

Please refer to FIG. 10. FIG. 10 is a diagram illustrating a touch panel module according to a third embodiment of the present invention. As shown in FIG. 10, the touch panel module 1000 comprises a surface panel 1010, a first retro-reflector 1012, a second retro-reflector 1014, a third retro-reflector 1016, a band splitter 1020, a first optical unit 1030, a second optical unit 1032, and a control unit 1040, where the first, second, and third retro-reflectors 1012, 1014, 1016 are positioned at a first side, a second side, and a third side of the surface panel 1010, respectively. In addition, the band splitter 1020 is positioned upon the third retro-reflector 1016, where a light beam having frequencies within a first band is totally reflected by the band splitter 1020, and a light beam having frequencies within a second band transmits to the band splitter 1020. The second optical unit 1032 is positioned near the third side of the surface panel 1010.

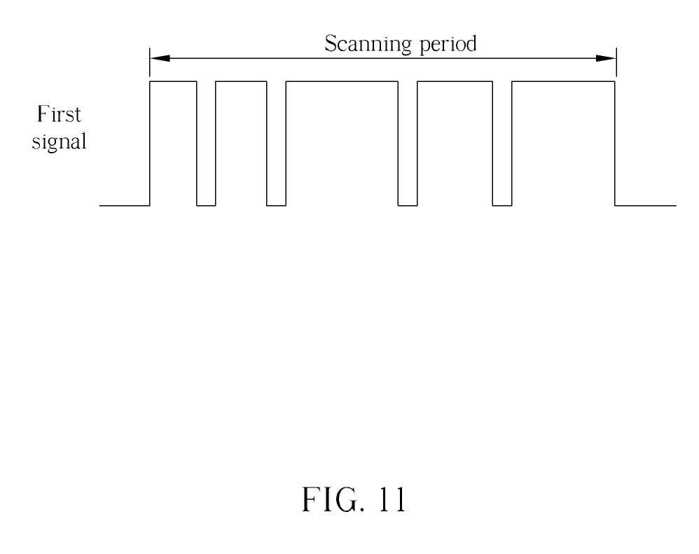

The difference between the touch panel module 1000 and the touch panel module 300 is that the touch panel module 1000 further comprises the second optical unit 1032. In general operations, the optical unit 1032 is disabled, and the operations of the touch panel module 1000 is similar to that of the touch panel module 300. Therefore, in the following description, functions of the elements and meanings of the signals in the touch panel module 1000 is the same as that in the touch panel module 300. Therefore, similar operations in the touch panel module 1000 are omitted here. When four pulses are in the first signal during the scanning period shown in FIG. 11 (the first signal is generated from the first optical unit 1030), it represents that there are two touch objects on the surface panel 1010. At this time, the control unit 1040 enables the second optical unit 1032 and a second light source in the first optical unit 1030. The first optical unit 1030 receives a reflected second band light beam reflected by one of the second and third retro-reflectors 1014, 1016 to generate a second signal. In addition, the second optical unit 1032 emits a light beam, and receives a reflected light beam reflected by one of the first and second retro-reflectors 1012, 1014 to generate a third signal. Then the control unit 1040 detects the two touch points according to the first and second signal from the first optical unit 1030 and the third signal from the second optical unit 1032, and calculates the positions of the two touch objects. Compared with the touch panel module 300, the operations of the touch panel module 1000 further comprises the steps of detecting the two touch objects on the surface panel 1010 according to the third signal generated from the second optical unit 1032. A person skilled in this art can readily insert the steps of detecting two touch objects at the same time into the flowchart shown in FIG. 5 after reading the above disclosure of the touch panel module 300 (e.g., adding these steps into Step 514 shown in FIG. 5), further description is omitted here for the sake of brevity.

In addition, in this embodiment, the second optical unit 1032 is positioned near a lower left corner of the surface panel 1010, and is able to receive the reflected light beam reflected by one of the first and second retro-reflectors 1012, 1014 to generate the third signal. However, in another embodiment of the present invention, by changing the relative position of the second optical unit 1032, the second optical unit 1032 can receive the reflected light beam reflected by one of the first, second, and third retro-reflectors 1012, 1014, 1016 to generate the third signal. Theses alternative designs are all within the scope of the present invention.

Those skilled in the art will readily observe that numerous modifications and alterations of the device and method may be made while retaining the teachings of the invention.

What is claimed is:

1. A touch panel module, comprising:
a surface panel, wherein borders with a setting pattern are positioned at a first side and a second side of the surface panel, and the second side neighbors the first side;
a mirror, positioned at a third side of the surface panel, wherein the third side is opposite to the first side;
a photographic fetching unit, for fetching images of the first side and the second side of the surface panel, wherein the images of the first side and the second side are a physical image of the second side and a mirrored image of the first and second side of the surface panel; and
a control unit, coupled to the photographic fetching unit, for performing touch point detection according to the images of the first and the second side of the surface panel fetched by the photographic fetching unit.

2. The touch panel module of claim 1, wherein when a touch point is on the surface panel, the control unit determines two angles relative to a reference line according to the images of the first and the second side of the surface panel fetched by the photographic fetching unit, and calculates the position of the touch point on the surface panel according to the two angles.

3. The touch panel module of claim 1, further comprising:
an ambient light detection unit, coupled to the control unit, for detecting an intensity of the ambient light;
a light source, coupled to the control unit, wherein the control unit controls the brightness of the light source according to the intensity of the ambient light.

4. A touch panel module, comprising:
a surface panel, wherein a first retro-reflector, a second retro-reflector, and a third retro-reflector are respectively positioned at a first side, a second side, and a third side of the surface panel, and the second side neighbors the first side, and the third side is opposite to the first side;
a first band splitter, positioned upon the third retro-reflector, wherein a light beam having frequencies within a first band is totally reflected by the first band splitter, and a light beam having frequencies within a second band transmits to the first band splitter;
a first optical unit, for generating a first band light beam having frequencies within the first band, and for receiving a reflected first band light beam reflected by one of the first and second retro-reflectors to generate a first signal; and
a control unit, coupled to the first optical unit, for performing touch point detection according to the first signal.

5. The touch panel module of claim 4, wherein the first optical unit comprises:
a first light source, for generating a first band light beam having frequencies within the first band;
a second band splitter, for totally reflecting the first band light beam generated from the first light source;
a beam splitter;
a polygon mirror, for making the first band light beam scan over the surface panel; and
a photo sensor, for receiving the reflected first band light beam reflected by one of the first and second retro-reflectors to generate the first signal.

6. The touch panel module of claim 5, wherein the first optical unit further comprises:
a second light source, for generating a second band light beam having frequencies within the second band, wherein the polygon mirror is utilized for making the first band light beam and the second band light beam scan over the surface panel, and the photo sensor is further utilized for receiving a reflected second band light beam reflected by one of the second and third retro-reflectors to generate a second signal, and the control unit is utilized for performing touch point detection according to the first signal and the second signal.

7. The touch panel module of claim 6, wherein the polygon mirror is utilized for making the first band light beam scan over the surface panel during a scanning period, and the control unit only enables the second light source when there is only one pulse or more than two pulses in the first signal during the scanning time.

8. The touch panel module of claim 6, further comprising:
a second optical unit, for generating a light beam, and for receiving a reflected light beam reflected by one of the first, second, and third retro-reflectors to generate a third signal, wherein the control unit detects a plurality of touch points on the surface panel according to the first signal, the second signal, and the third signal.

9. The touch panel module of claim 8, wherein the polygon mirror is utilized for making the first band light beam scan over the surface panel during a scanning period, and the control unit only enables the second optical unit when there is more than two pulses in the first signal during the scanning time.

10. The touch panel module of claim 4, wherein the first optical unit comprises:
a first light source, for generating a first band light beam having frequencies within the first band;
a second band splitter, for totally reflecting the first band light beam generated from the first light source;
a beam splitter;
a lens assembly, for diverging the first band light beam over the surface panel; and
a photo sensor, for receiving the reflected first band light beam reflected by one of the first and second retro-reflectors to generate the first signal.

11. The touch panel module of claim 10, wherein the first optical unit further comprises:
a second light source, for generating a second band light beam having frequencies within the second band, wherein the lens assembly is utilized for diverging the first band light beam over the surface panel, and the photo sensor is further utilized for receiving a reflected second band light beam reflected by one of the second and third retro-reflectors to generate a second signal, and the control unit is utilized for performing touch point detection according to the first signal and the second signal.

12. The touch panel module of claim 11, wherein the control unit enables or disables the second light source according to the first signal.

13. The touch panel module of claim 11, further comprising:
a second optical unit, for generating a light beam, and for receiving a reflected light beam reflected by one of the first, second, and third retro-reflectors to generate a third signal, wherein the control unit detects a plurality of touch points on the surface panel according to the first signal, the second signal, and the third signal.

14. The touch panel module of claim 13, wherein the control unit enables or disables the second optical unit according to the first signal.

15. A method for determining a position of a touch point on a touch panel, comprising:
positioning borders with a setting pattern at a first side and a second side of a surface panel, wherein the second side neighbors the first side;
positioning a mirror at a third side of the surface panel, wherein the third side is opposite to the first side;
fetching a physical image of the second side and a mirrored image of the first and second side of the surface panel; and
performing touch point detection according to fetched images of the first and the second side of the surface panel.

16. The method of claim 15, wherein when a touch point is on the surface panel, the method further comprises:
determining two angles relative to a reference line according to the images of the first and the second side of the surface panel, and calculating the position of the touch point on the surface panel according to the two angles.

17. A method for determining a position of a touch point on a touch panel, comprising:
respectively positioning a first retro-reflector, a second retro-reflector, and a third retro-reflector at a first side, a second side, and a third side of a surface panel, wherein the second side neighbors the first side, and the third side is opposite to the first side;
positioning a band splitter upon the third retro-reflector, wherein a light beam having frequencies within a first band is totally reflected by the band splitter, and a light beam having frequencies within a second band transmits to the band splitter;
generating a first band light beam having frequencies within the first band;
receiving a reflected first band light beam reflected by one of the first and second retro-reflectors to generate a first signal; and
performing touch point detection according to the first signal.

18. The method of claim 17, further comprising:
generating a second band light beam having frequencies within the second band;
receiving a reflected second band light beam reflected by one of the second and third retro-reflectors to generate a second signal; and
performing touch point detection according to the first signal and the second signal.

19. The method of claim 18, further comprising:
determining whether to generate the second band light beam or not according to the first signal.

20. The method of claim 18, further comprising:
generating a light beam;
receiving a reflected light beam reflected by one of the first and second retro-reflectors to generate a third signal; and
detecting a plurality of touch points on the surface panel according to the first signal, the second signal, and the third signal.

21. The method of claim 20, further comprising:
determining whether to generate the light beam or not according to the first signal.
